(19) United States
(12) Patent Application Publication
(10) Pub. No.: US 2006/0139906 A1
(43) Pub. Date: Jun. 29, 2006

(54) Illuminant button structure

(76) Inventors: Tsung Kai Lin, Taipei City (TW); Lii Hwang Chen, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 11/094,251

(22) Filed: Mar. 31, 2005

(30) Foreign Application Priority Data
Dec. 29, 2004 (TW) 093141131

(51) Int. Cl. G01D 11/28

(52) U.S. Cl. 362/23

(57) ABSTRACT

The present invention concerns to an illuminant button structure that can be set on the front side of a media center extender. The illuminant button structure comprises a button base plate, a light source and a light transmitting button cap. There is a containing chamber on the button base plate in which a fixing groove is set to fix the aforesaid light source. The light transmitting button cap includes a light-entering surface and a light-exiting surface, wherein the light-entering surface forms a light transmitting curved surface and also a ring shaped light display area on the exterior surface; as a result, the light from the light source can be evenly emitted.

### BACKGROUND OF THE INVENTION

1. Field of the Invention

The present invention relates to an illuminant button structure and more particularly, to an illuminant structure of a media center extender's directional button.

2. Description of Related Art

Light Emitting Diode (LED) has been widespread used in all the household appliances, such as Personal Digital Assistant (PDA), cell phone, digital camera and video camera. These products use white LED and color red, green, and blue LED in great deal. In order to transmit light in a large area, several LED are displaced on the base plate behind where the light is desired to be show. However, this method would raise the cost and cause the waste of the components, and also accompany with the drawback of concentrating light spot and uneven light source.

Therefore, it is desirable to provide an illuminant button structure of the present invention that eliminates the aforesaid problems.

### SUMMARY OF THE INVENTION

The illuminant button structure of the present invention comprises a button base plate, a light source and a light transmitting button cap. The aforesaid button base plate possesses a containing chamber and this containing chamber includes an opening, a containing space and a fixing groove. The aforesaid light source is fixed in the fixing groove in the containing chamber of the button base plate and includes a LED lamp and a LED PCB (printed circuit board). The light transmitting button cap is to cover up the opening of the containing chamber, and further, it has a light-entering surface and a light-exiting surface. The light-entering surface forms a light transmitting curved surface make the light be transmitted evenly. Therefore, the present invention only needs one LED lamps to improve the defects of concentrating light spot and uneven light display furthermore, to prevent the waste of source.

The light display area can be any geometric figures, such as a ring, a triangular form, and a square have the same effect.

### BRIEF DESCRIPTION OF THE DRAWINGS

FIG. 1 is a perspective view of the media center extender of the present invention.

FIG. 2 is an exploded view of the media center extender's directional button of the present invention.

FIG. 3 is a schematic drawing of the media center extender's directional button cap of the present invention.

FIG. 4 is a sectional view of the directional button of the media center extender of the present invention.

### DETAILED DESCRIPTION OF THE PREFERRED EMBODIMENT

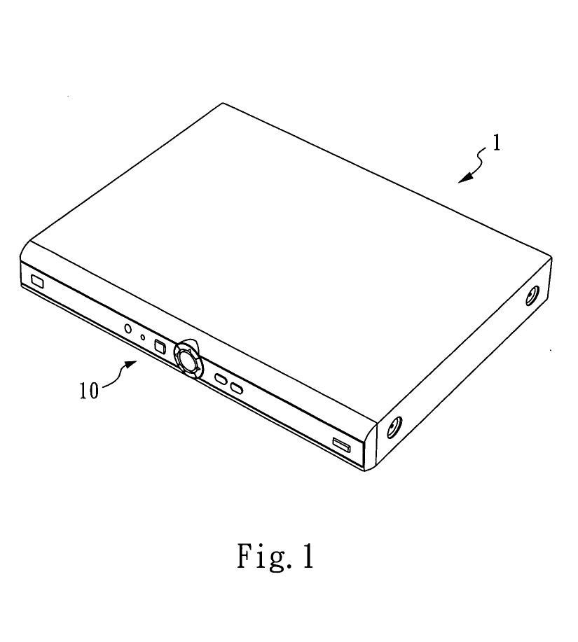

Referring to FIG. 1, the illuminant button structure 10 is set on the front side of the media center extender 1 with the function of directional button.

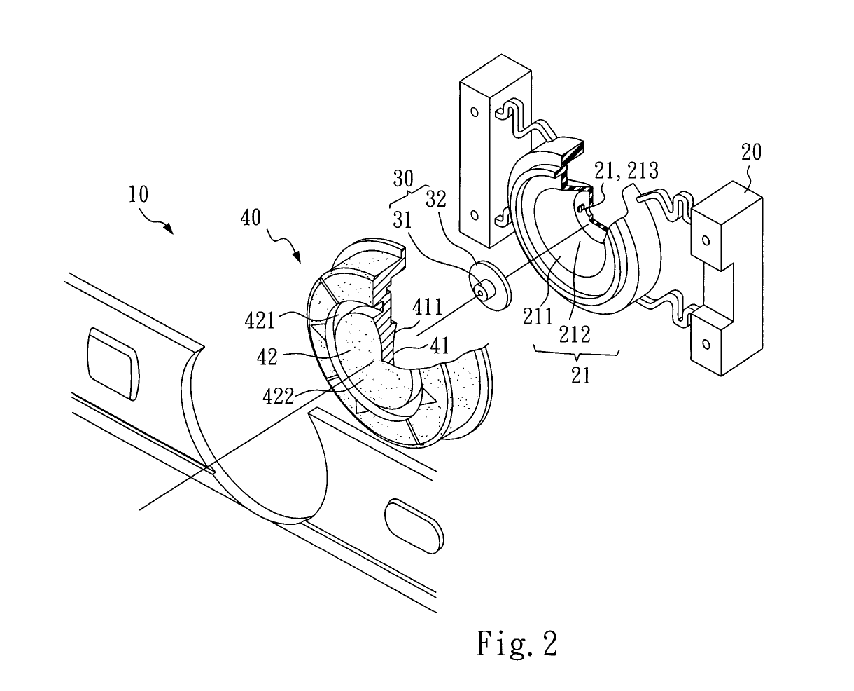

Referring to FIG. 2, the illuminant button structure 10 comprises a button base plate 20, a light source 30 and a light transmitting button cap 40. Wherein the button base plate 20 includes a containing chamber 21 that has an opening 211, a containing space 212 and a fixing groove 213, so that the light source 30 can be fixed in the fixing groove 213 of the containing chamber 21. The light source 30 comprises a LED lamp 31 and a LED PCB 32, and the LED PCB 32 supplies the power and controls the LED lamp 31 to emit light. In this embodiment, the LED lamp 31 is a tricolor lamp of red, green and blue color that radiate a red, green, blue or mixed light in accordance with the control of LED PCB 32.

The aforesaid light transmitting button cap 40 can exactly cover up the opening 211 of the containing chamber 21 of the button base plate 20, and the button cap 40 has a light-entering surface 41 and a light-exiting surface 42. The light-entering surface 41 forms a light transmitting curved surface 411 that can transmit the light from LED lamp 31 evenly. The light-exiting surface 42 includes a light display area 421 and a shelter area 422 and the light can be emitted evenly through the light display area 421.

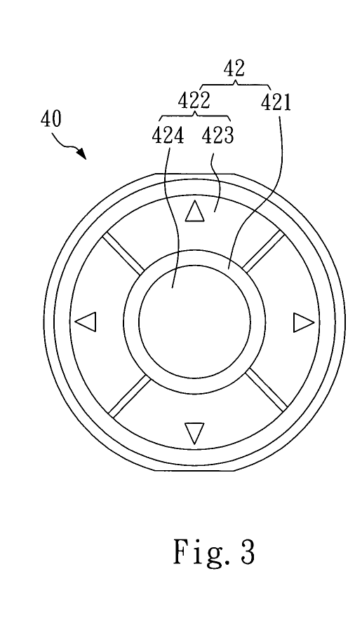

Referring to FIG. 3, the light-exiting surface 42 of the light transmitting button cap 40 has a ring-shape light display area 421 and a shelter area 422 and the shelter area 422 includes an interior shelter area 424 and an exterior shelter area 423 that can be formed by spray paint and laser. In this preferred embodiment, the light display area 421 is a ring, however, the shape of the light display area may be different geometric figures applied to different design of the button to have the same effect of even light transmission.

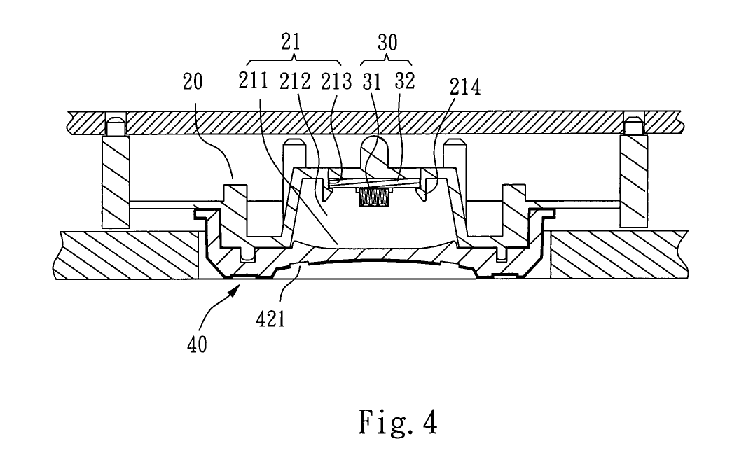

FIG. 4 illustrates clearly the integrated structure of light transmitting button cap 40 and button base plate 20. The containing chamber 21 of the button base plate 20 includes an opening 211, a containing space 212 and a fixing groove 213, and the light transmitting button cap 40 can justly cover up the opening 211 of the containing chamber 21. Furthermore, there are multiple fixing hooks 214 on the fixing groove 213. When the light source 30 is set in the fixing groove 213, the fixing hooks 214 may fix the LED PCB 32 of the light source 30 to prevent the light source 30 to move in the containing space 212; as a result, the light emitted from the LED lamp 31 could evenly display on the light display area 421 of the light transmitting button cap 40.

Although the present invention has been explained in relation to its preferred embodiment, it is to be understood that many other possible modifications and variations can be made without departing from the spirit and scope of the invention as hereinafter claimed.

What is claimed is:

1. An illuminant button structure, comprising:
a button base plate, possessing a containing chamber, said containing chamber includes an opening, a containing space and a fixing groove;
a light source, fixed on said fixing groove in said containing chamber of said button base plate, said light source including a Light Emitting Diode lamp and a LED PCB; and
a light transmitting button cap, covering up said opening of said containing chamber, said light transmitting button cap including a light-entering surface and a light-exiting surface and said light-entering surface forms a light transmitting curved surface.

2. The illuminant button structure as claimed in claim 1, wherein said light-exiting surface of said light transmitting button cap includes a light display area and a shelter area.

3. The illuminant button structure as claimed in claim 2, wherein said shelter area is formed by spray paint.

4. The illuminant button structure as claimed in claim 2, wherein said light display area is a ring.

5. The illuminant button structure as claimed in claim 1, wherein said fixing groove of said button base plate includes multiple fixing hooks to fix said LED PCB of said light source.

6. The illuminant button structure as claimed in claim 1, wherein said LED lamp is a tricolor lamp of red, green and blue color.

7. The illuminant button structure as claimed in claim 1 being a button structure for direction.
